(19) United States
(12) Patent Application Publication
(10) Pub. No.: US 2005/0233922 A1
(43) Pub. Date: Oct. 20, 2005

(54) Cleaning solution and method of cleaning semiconductor devices using the same

(75) Inventors: Myoung-Ho Jung, Yongin-si (KR); Hyun-Woo Kim, Hwasung-gun (KR); Sang-Gyun Woo, Yongin-si (KR); Jin-Bae Jeong, Ulsan-si (KR); Hyun-Jin Jeong, Ulsan-si (KR); Jae-Woong Moon, Yangsan-si (KR)

Correspondence Address: Eugene M. Lee;LEE, STERBA & MORSE, PC, Suite 2000, 1101 Wilson Boulevard, Arlington, VA, 22209, US

(73) Assignee: Samsung Electronics Co., Ltd.

(21) Appl. No.: 11/048,069

(22) Filed: Feb. 2, 2005

(30) Foreign Application Priority Data
Feb. 3, 2004 (KR) 2004-6986

(51) Int. Cl. C11D 1/00

(52) U.S. Cl. 510/175

(57) ABSTRACT

A cleaning solution for preventing the collapse of photoresist patterns and a method of cleaning a semiconductor device using the cleaning solution; the cleaning solution includes a solvent and a surfactant and has a dynamic surface tension of about 50 dyne/cm or less at about 6 bubbles/seconds when measured by a maximum bubble pressure method. The collapse of the photoresist pattern can be prevented using the cleaning solution when forming minute photoresist patterns having about 100 nm or less pattern width. The cleaning solution containing a surfactant in a high concentration also can be prepared to reduce distribution expenses.

### CROSS REFERENCE TO RELATED APPLICATION

This application claims priority under 35 USC § 119 to Korean Patent Application No. 2004-6986 filed on Feb. 3, 2004, the content of which is incorporated herein by reference in its entirety.

### BACKGROUND OF THE INVENTION

1. Field of the Invention

Embodiments of the present invention relate to a cleaning solution and to a method of cleaning a semiconductor device using the same. More particularly, the embodiments relate to a cleaning solution for a photoresist pattern that effectively prevents collapse of the pattern and a method of cleaning a semiconductor device using the same.

2. Description of the Related Art

Semiconductor devices having a high integration degree and rapid response speed may be desired as information processing apparatuses have been developed. Hence, the technology of manufacturing semiconductor devices has developed to improve the integration degree, reliability and response speed of semiconductor devices. Accordingly, micro-processing technology such as a photolithography process may be performed more precisely to improve the integration degree of the semiconductor device.

The photolithography process is used for forming minute electronic circuit patterns on a substrate. That is, the substrate to which the photoresist is coated is exposed to light through a mask having a circuit pattern to transfer the circuit patterns of the mask to the substrate.

The light applied in the photolithography process includes a G-line ray, an I-line ray, a laser of krypton fluoride (KrF), a laser of argon fluoride (ArF), an e-beam, an X-ray, etc. Among the lights, the G-line ray has the longest wavelength while the X-ray has the shortest wavelength.

Previously, the integration degree of the semiconductor device was low so that the size of the photoresist pattern for forming a circuit on the substrate was relatively large. However, as the semiconductor industry has developed, the integration degree of the device has gradually increased. Accordingly, very minute photoresist patterns also are required. In order to form the very minute photoresist patterns, a light having shorter wavelength should be applied during the exposing process.

Basic processes for forming the above-mentioned photoresist patterns are as follows.

A photoresist composition is uniformly coated by spin coating on a substrate such as a wafer to which an oxide layer or a metal layer is coated. Then, the coated photoresist film is soft baked to remove the solvent in the photoresist to form a uniform and dry photoresist film. Subsequently, the photoresist film on the substrate is exposed to a light having a predetermined wavelength through a mask having a predetermined circuit pattern. The photoresist film is divided into two portions having an exposed portion and an unexposed portion according to the shape of the circuit pattern of the mask. The exposed portion is chemically transformed due to a photoreaction resulting in different physical and chemical properties with respect to the unexposed portion.

The treated photoresist film is developed in the subsequent process. The exposed portion or the unexposed portion of the photoresist film selectively reacts with the developing solution according to the kind of photoresist to remove predetermined portions so that desired photoresist patterns are obtained through the developing process.

The developing process is performed by dipping the substrate into a developing solution, by spraying the developing solution onto the substrate or by using a puddle method of applying the developing solution on the surface of the substrate. Then, the developing solution at the surface portion of the substrate is cleaned using a cleaning solution such as pure water (or ultrapure water). The substrate is dried by a spin dry method to complete the photoresist pattern.

However, as the integration degree of the semiconductor device increases as described above, the photoresist patterns become more minute. Therefore, after replacing the developing solution with pure water, collapse of the photoresist patterns may be easily generated.

The mechanism of collapse of the photoresist pattern is explained in literature suggested by Tanaka et al. in the title of “Mechanism of Resist Pattern Collapse During Development Process” (Japan J. Appl. Phys. vol. 32 (1993)). That is, the literature explains that the photoresist pattern collapse occurs during drying process after replacing the developing solution with ultrapure water. The collapse of the photoresist pattern is known to be generated by the capillary force caused by a cleaning solution such as pure water filling the areas between the developed photoresist patterns. The capillary force may be expressed in accordance with the following Equation 1.
ΔP=2γ cos θ/S [Equation 1]

In Equation 1, γ represents a surface tension of the cleaning solution, θ represents the contacting angle between the cleaning solution and the pattern, and S represents the distance between patterns.

According to Equation 1, the capillary force is proportional to the surface tension of the cleaning solution and the cosine of the contacting angle between the cleaning solution and the pattern. However, the capillary force is inversely proportional to the distance between the patterns. Also, according to Tanaka's teaching, as the aspect ratio (the ratio of the height and the width of the pattern) gradually increases, the pattern becomes even more liable to be deformed due to the capillary force.

When considering a manufacturing process employing the G-line ray, the I-line ray or the laser of krypton fluoride (KrF), the integration degree of the semiconductor device is relatively low and the distance between patterns is relatively large. Therefore, when pure water having very high surface tension is used as a cleaning solution, the capillary force does not easily generate collapse of the patterns. In addition, when the capillary force is substantially large, the pattern does not easily collapse because the pattern width is sufficiently large.

However, electronic circuits such as the semiconductor devices require ever more highly integrated circuits to increase their performance. This requires even more minute photoresist patterns with even smaller distance between photoresist patterns. Correspondingly, circuits having a pattern width and a pattern distance of about 100 nm or less are required.

In order to accomplish the above-suggested requirements, a process utilizing the laser of krypton fluoride (KrF) for forming a minute pattern has been employed or a process utilizing the laser of argon fluoride (ArF), the e-beam or the X-ray has been developed. That is, as the photoresist pattern width and the distance between patterns decreases, the influence of the capillary force increases. Accordingly, collapse of the photoresist pattern is generated even more easily when applying the conventional cleaning method using pure water.

In order to solve the above-mentioned problems, various research endeavors have been executed in the allied industrial field. For example, a method of using a solvent having a low surface tension such as alcohol to decrease the surface tension of the cleaning solution, which is the cause of the capillary force, or a method of using a solvent obtained by adding the alcohol to pure water is known (Tanaka et al., Japan J. Appl. Phys. vol. 32 (1993), p 6095; John Simons et al., SPIE proc., vol. 4345 (2001), p 19). Other methods including a cleaning method utilizing a super critical fluid (John Simons et al., SPIE proc., vol. 4345 (2001), p 19; Korean Laid-open Patent Publication No. 10-2002-0083462), and a method of cleaning using pure water having a low surface tension by heating the pure water (U.S. Pat. No. 5,474,877), and the like, are known.

However, when a solvent having a low surface tension is used as a cleaning solution, the solvent dissolves the photoresist pattern, generating a deformation of the pattern. When a cleaning solution obtained by adding a solvent having a low surface tension into pure water is used, the mixing ratio of the solvent having the low surface tension preferably is high in order to decrease the surface tension of the pure water, which may generate other side effects due to the high concentration of solvent.

Further, the method utilizing the super critical fluid is economically disadvantageous because of problems such as high cost, low production efficiency, and the like.

A method using a surfactant has been developed to prevent the collapse of the photoresist pattern. For example, a method using various kinds of fluoric surfactants that have very low equilibrium surface tension or static surface tension is disclosed by Stefan Hien, et al., SPIE proc., vol. 4690(2002), p 254.

However, according to the Stefan Hien, et al. teaching, some of the suggested surfactants have relatively high equilibrium surface tension and γ cos θ values as the numerator in the Equation 1, but exhibit less frequent occurrence of the pattern collapse. This phenomenon can not be explained according to the Stefan Hien, et al. teaching, implying the presence of another factor influencing the capillary force besides the equilibrium surface tension or the static surface tension. That is, a detailed mechanism describing the capillary force is not verified in Stefan Hien, et al. Therefore, the application is limited and an effect is not guaranteed when applying the method in practical processes.

A cleaning solution utilizing an aqueous solution including a fluoric surfactant of a low equilibrium surface tension or a low static surface tension is disclosed in Korean Laid-open Patent Publication No. 10-2002-68679.

The application of some fluoric surfactants having a low equilibrium surface tension or static surface tension as a component of a cleaning solution is suggested in the above-mentioned Korean patent. According to the method of the patent, some fluoric surfactants having low equilibrium surface tension can be used for the preparation of the cleaning solution. However, the high/low degree of the equilibrium surface tension or static surface tension does not directly affect the collapse of the pattern. Therefore, the practical application of the method is limited.

The verification on the factors influencing the capillary force concerning the photoresist patterns and the development of a cleaning solution for preventing the collapse of the photoresist pattern is required.

The description herein of disadvantages and problems associated with known compositions, methods, and systems is in no way intended to limit the invention to their exclusion. Indeed, various embodiments of the invention may include various known components of compositions, methods, and systems without suffering from some of the disadvantages and problems previously attributed thereto.

### SUMMARY OF THE INVENTION

Embodiments of the present invention provide a cleaning solution that may prevent photoresist patterns from collapsing.

Embodiments of the present invention also provide a method of cleaning a semiconductor device including photoresist patterns using the cleaning solution.

In accordance with one aspect of an embodiment of the present invention, a cleaning solution comprises a surfactant and a solvent. Dynamic surface tension of the solution measured by a maximum bubble pressure method is about 50 dyne/cm or less at about 6 bubbles/second. Here, the solution may include about 0.01 to 1.0 weight percent of the surfactant and about 99.0 to 99.99 weight percent of the solvent.

In accordance with another aspect of the present invention, there is provided a method of cleaning a semiconductor device. A photoresist pattern is formed on a substrate by developing a partially exposed photoresist film. Then, the substrate on which the photoresist pattern is formed is cleaned to replace the developing solution with a cleaning solution including a surfactant and a solvent. The cleaning solution may have a dynamic surface tension of about 50 dyne/cm at about 6 bubbles/second measured by a maximum bubble pressure method. The cleaning solution is removed from the substrate on which the photoresist pattern is formed.

According to one embodiment of the present invention, there is provided a method of cleaning a semiconductor device as follows. A partially exposed photoresist film formed on a substrate is developed using a developing solution to form a photoresist pattern. Then, the substrate on which the photoresist pattern is formed is cleaned using a cleaning solution including at least one surfactant selected from the group consisting of the compounds represented by the chemical formulae 1 to 6 set forth below in the Description of the Invention. The developing solution is replaced with cleaning solution. Subsequently, the cleaning solution is removed from the substrate on which the photoresist pattern is formed.

According to the present invention, the collapse of the photoresist pattern may be effectively prevented when forming minute photoresist patterns having pattern width of about 100 nm or less by using a cleaning solution having good dynamic surface tension characteristics. Various patterns of highly integrated semiconductor devices can be accurately and advantageously formed using the cleaning solution. In addition, when two or more surfactants are used in the cleaning solution, a cleaning solution containing a high concentration of surfactant may be prepared.

Thus, a highly integrated semiconductor device having improved reliability may be economically manufactured so that the time and cost required for the manufacturing the semiconductor device may be reduced.

### BRIEF DESCRIPTION OF THE DRAWINGS

The above and other features and advantages of the embodiments of the invention will become readily apparent by reference to the following detailed description when considered in conjunction with the accompanying drawings in which:

FIG. 1 is a flow chart illustrating a method of cleaning semiconductor devices in accordance with one embodiment of the present invention;

FIGS. 2A to 2F are cross-sectional views illustrating a method of cleaning semiconductor devices in accordance with one embodiment of the present invention; and

FIGS. 3A to 3C are enlarged cross-sectional views of part I in FIG. 2F illustrating a mechanism of altering the dynamic surface tension in accordance with one embodiment of the present invention.

### DESCRIPTION OF THE INVENTION

The present invention now will be described more fully hereinafter with reference to the accompanying drawings, in which embodiments of the invention are shown. The present invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element such as a layer, a region or a substrate is referred to as being “on” or “onto” another element, it can be directly on the other element or intervening elements also may be present.

In the present invention, a cleaning solution includes a surfactant and a solvent that may prevent collapse of photoresist patterns during cleaning of the photoresist patterns.

According to one embodiment of the present invention, the cleaning solution includes a surfactant and a solvent, and has a dynamic surface tension of less than or substantially identical to about 50 dyne/cm at about 6 bubbles/second measured by the maximum bubble pressure method.

Collapse of the photoresist pattern may be effectively prevented by reducing the capillary force due to the cleaning solution that remains between photoresist patterns. In order to decrease the capillary force, reducing the surface tension during a spin-dry process is required because the capillary force is proportional to the surface tension of a liquid as illustrated in Equation 1.

When the solution includes a surfactant, the surface tension commonly represents an equilibrium surface tension or a static surface tension. The surface tension is achieved when the molecules of the surfactant having both hydrophobic and hydrophilic functional groups move to the surface of the solution, are adsorbed and are arranged to saturate the surface of the solution with the surfactant molecules. That is, the surface tension is obtained after waiting a period of time for the surfactant molecules to reach the final state of minimum surface tension.

When the final surface tension is substantially low and the time required to reach the final surface tension is relatively short, the collapse of the photoresist pattern is effectively prevented. The surface tension of the present embodiment is not the final equilibrium surface tension or the static surface tension, but the dynamic surface tension. The dynamic surface tension is envisioned by considering a time concept, which has not been considered for envisioning the equilibrium surface tension or the static surface tension.

An advantageous dynamic surface tension is one in which the surface tension is lowered by the rapid movement, adsorption and arrangement of the molecules of the surfactant after a new gas (for example, an air or a process atmosphere)-liquid(for example, a cleaning solution) interface is formed.

Generally, a period from a few tens of seconds to a few days is required for the molecules of the surfactant in the liquid to saturate the gas-liquid interface after forming a new gas-liquid interface. Before the gas-liquid interface reaches an equilibrium state, photoresist patterns are exposed to a high gas-liquid surface tension, that is, exposed to a high capillary force. Therefore, when a cleaning solution having a low equilibrium surface tension but poor dynamic surface tension characteristics is used, the photoresist patterns may easily collapse before the gas-liquid interface reaches the low surface tension equilibrium state.

The collapse of the photoresist pattern may be prevented using a cleaning solution having a low dynamic surface tension. In particular, a cleaning solution having a dynamic surface tension of less than or substantially identical to about 50 dyne/cm at about 6 bubbles/second measured by a maximum bubble pressure method may be used in accordance with the present invention.

Preferably, the dynamic surface tension is about 45 dynes/cm or less at about 6 bubbles/second. When the dynamic surface tension is more than about 50 dyne/cm at about 6 bubbles/second, the capillary force between the photoresist patterns remains strong for a long period of time so that the photoresist pattern may easily collapse.

The factors influencing the dynamic surface tension characteristics of the cleaning solution including pure water and the surfactant may be the temperature of the cleaning solution, the concentration of the surfactant, the kind of the surfactant, the addition of an organic solvent, etc. Using the guidelines provided herein, skilled artisans are capable of modifying any or a any combination of these variables to achieve the desired surface tension.

Referring to the temperature of the cleaning solution, the surface tension of the pure water is inversely proportionally to the temperature of the cleaning solution. As the temperature of the solution increases and the mobility of the surfactant molecules increases, the surface tension of the solution decreases, improving the dynamic surface tension characteristics. On the contrary, when the temperature of the cleaning solution decreases, the dynamic surface tension characteristics are deteriorated. Because the application temperature of the cleaning solution is dependent on processing conditions such as the developing process conditions, process temperature often may not be adjusted. Thus, the ability to decrease the dynamic surface tension through the heightening of the temperature of the cleaning solution is limited. That is, the accomplishment of a low dynamic surface tension may be advantageously acheived by adjusting other factors within a wide temperature range.

The dynamic surface tension becomes strong when the concentration of the surfactant increases. However, when the concentration of the surfactant is excessively high, the generation of bubbles becomes vigorous. In addition, the cleaning solution remains at the surface portion of the photoresist patterns, generating a problem during subsequent processes. Accordingly, cleaning solutions including a surfactant having an excessively high concentration are not preferred. Therefore, the improvement of the dynamic surface tension characteristics by only increasing the concentration of the surfactant also is limited. That is, a surfactant having good dynamic surface tension characteristics should be selected and be used at an appropriate concentration.

Pure water (or ultrapure water) may be used as the solvent, and at least one surfactant selected from the group consisting of the following compounds represented by chemical formulae 1 to 6 may be used. Additionally, two or more compounds may be selected and combined for use as the surfactant.

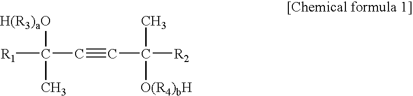

In chemical formula 1, R1 and R2 independently represent branched or straight chain saturated hydrocarbon groups having about 3 to 6 carbon atoms, R3 and R4 indicate oxyalkylene units, and a and b represent integers of 0 to 10. Preferably, R1 and R2 have about 4 to 5 carbon atoms, and a and b represent integers of from 0 to 5. Examples of the oxyalkylene unit of R3 and R4 may include an oxyethylene unit (—C₂H₄O—), an oxypropylene unit (—C₃H₆O—), a combination of an oxyethylene and an oxypropylene unit, etc.

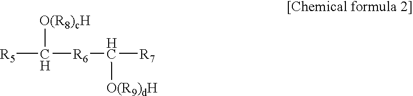

In chemical formula 2, R5, R6 and R7 independently represent hydrogen atoms (H) or branched or straight chain saturated hydrocarbon groups having about 1 to 11 carbon atoms, R8 and R9 independently indicate oxyalkylene units, and c and d represent integers of from 0 to 10. Preferably, c and d represent integers of 1 to 5. Examples of the oxyalkylene unit of R8 and R9 may include an oxyethylene unit (—C₂H₄O—), an oxypropylene unit (—C₃H₆O—), a combination of an oxyethylene and an oxypropylene unit, etc.

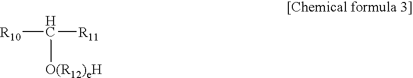

In chemical formula 3, R10 and R11 independently represent hydrogen atoms (H) or branched or straight chain saturated hydrocarbon groups having about 1 to 12 carbon atoms, R12 indicates an oxyalkylene unit, and e represents an integer of from 1 to 15. Preferably, e represents an integer of 5 to 13. Examples of the oxyalkylene unit of R12 may include an oxyethylene unit (—C₂H₄O—), an oxypropylene unit (—C₃H₆O—), a combination of an oxyethylene and an oxypropylene unit, etc.

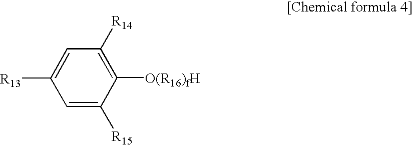

In chemical formula 4, R13, R14 and R15 independently represent hydrogen atoms or benzylmethyl groups having a benzene ring, R16 indicates an oxyalkylene unit and f represents an integer of from 1 to 15. Preferably, f represents an integer of from 3 to 10. Examples of the oxyalkylene unit of R16 may include an oxyethylene unit (—C₂H₄O—), an oxypropylene unit (—C₃H₆O—), a combination of an oxyethylene and an oxypropylene unit, etc.

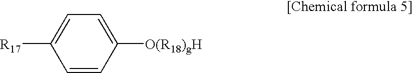

In chemical formula 5, R17 represents a branched or a straight chain saturated hydrocarbon group having about 6 to 10 carbon atoms, R18 represents an oxyalkylene unit and g represents an integer of from 1 to 15. Preferably, g represents an integer of from 3 to 10. Examples of the oxyalkylene unit of R18 may include an oxyethylene unit (—C₂H₄O—), an oxypropylene unit (—C₃H₆O—), a combination of an oxyethylene and an oxypropylene unit, etc.

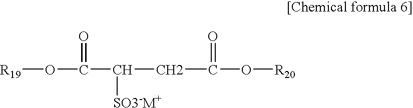

In chemical formula 6, R19 and R20 independently represent branched or straight chain saturated hydrocarbon groups having about 5 to 12 carbon atoms, and M represents ammonia or alkanolamine. Preferably, R19 and R20 have about 7 to 9 carbon atoms. Examples of ammonia and alkanolamine may include ammonia, mono-ethanol amine, diethanol amine and triethanol amine.

The cleaning solution including the solvent and the surfactant can further include about 0 to 30 weight percent of an organic solvent based on about 70 to 100 weight percent of the cleaning solution. Examples of the organic solvent may include methyl alcohol, ethyl alcohol, isopropyl alcohol, butyl alcohol, a mixture thereof, etc.

According to one embodiment of the present invention, a cleaning solution includes a solvent and at least one surfactant selected from the group consisting of the compounds represented above by chemical formulae 1 to 6.

Most of the surfactants having good dynamic surface tension in the embodiments of the present invention include only a small molecular weight of hydrophilic functional groups so that only a relatively small amount of the surfactants can be dissolved in water. Accordingly, increasing the concentration of the surfactant to improve the dynamic surface tension characteristics of the cleaning solution is difficult. A surfactant having a high molecular weight of hydrophilic functional groups and liable to dissolve in water can be included as a dissolving agent to easily dissolve the surfactant having good dynamic surface tension characteristics but a low solubility in water. Therefore, a cleaning solution having even more enhanced dynamic surface tension characteristics can be prepared.

When two or more surfactants are combined, a cleaning solution having the surfactant in a high concentration can be prepared in advance and can be diluted in pure water at a time just before application. Thus, the distribution expenses from the manufacturing region to the applying region of the cleaning solution can be largely reduced. However, when the dynamic surface tension characteristics of the surfactant used as the dissolving agent are not good, the surfactant having excellent dynamic surface tension characteristics to be dissolved cannot exhibit the good cleaning characteristics due to the mixing. Rather, the performance of the cleaning solution may be lowered. Therefore, the surfactant used as the dissolving agent should be selected after sufficiently considering the dynamic surface tension characteristics thereof. The dissolving agent also can be selected among the surfactants represented by the above chemical formulae of 1 to 6.

The cleaning solution may include about 0.01 to about 1.0 weight percent of the surfactant and about 99.0 to 99.99 weight percent of the solvent such as pure water. Preferably, the cleaning solution includes about 0.03 to about 0.2 weight percent of the surfactant and about 99.8 to about 99.97 weight percent of the solvent. When the amount of the surfactant in the cleaning solution is less than about 0.01 weight percent, the improved efficiency of the dynamic surface tension characteristics is insufficient and the collapse of the photoresist pattern cannot be effectively prevented. When the amount of the surfactant exceeds about 1.0 weight percent, the solubility of the surfactant in the solvent may be lowered.

According to one embodiment of the present invention, the dynamic surface tension characteristics may be improved when an organic solvent that is miscible with water and has a lower surface tension than that of water is added to the cleaning solution. However, when the added amount of organic solvent exceeds about 30 weight percent, the organic solvent dissolves the photoresist, damaging the photoresist pattern. Thus, the cleaning solution may include less than or substantially identical to about 30 weight percent of the organic solvent. Examples of the organic solvent may include methyl alcohol, ethyl alcohol, isopropyl alcohol, butyl alcohol, etc. These can be used alone or in a combination thereof.

The cleaning solution for preventing the collapse of the photoresist pattern according to another embodiment of the present invention will be explained hereinafter.

The cleaning solution according to this embodiment includes a surfactant selected from the compounds represented by chemical formulae of 1 to 6 and a solvent such as pure water.

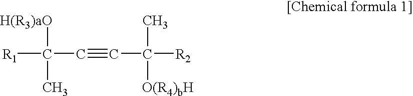

In chemical formula 1, R1 and R2 independently represent branched or straight chain saturated hydrocarbon groups having about 3 to 6 carbon atoms, R3 and R4 indicate oxyalkylene units, and a and b represent integers of 0 to 10. Preferably, R1 and R2 have about 4 to 5 carbon atoms, and a and b represent integers of from 0 to 5. Examples of the oxyalkylene unit of R3 and R4 may include an oxyethylene unit (—C₂H₄O—), an oxypropylene unit (—C₃H₆O—), a combination of an oxyethylene and an oxypropylene unit, etc.

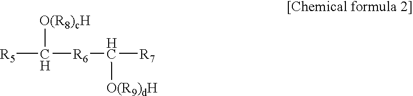

In chemical formula 2, R5, R6 and R7 independently represent hydrogen atoms (H) or branched or straight chain saturated hydrocarbon groups having about 1 to about 11 carbon atoms, R8 and R9 independently indicate oxyalkylene units, and c and d represent integers of from 0 to 10. Preferably, c and d represent integers of from 1 to 5. Examples of the oxyalkylene unit of R8 and R9 may include an oxyethylene unit (—C₂H₄O—), an oxypropylene unit (—C₃H₆O—), a combination of an oxyethylene and an oxypropylene unit, etc.

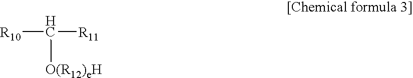

In chemical formula 3, R10 and R11 independently represent hydrogen atoms (H) or branched or straight chain saturated hydrocarbon groups having about 1 to about 12 carbon atoms, R12 indicates an oxyalkylene unit, and e represents an integer of from 1 to 15. Preferably, e represents an integer of from 5 to 13. Examples of the oxyalkylene unit of R12 may include an oxyethylene unit (—C₂H₄O—), an oxypropylene unit (—C₃H₆O—), a combination of an oxyethylene and an oxypropylene unit, etc.

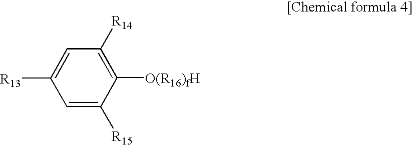

In chemical formula 4, R13, R14 and R15 independently represent hydrogen atoms or benzylmethyl groups having a benzene ring, R16 indicates an oxyalkylene unit and f represents an integer of from 1 to 15. Preferably, f represents an integer of from 3 to 10. Examples of the oxyalkylene unit of R16 may include an oxyethylene unit (—C₂H₄O—), an oxypropylene unit (—C₃H₆O—), a combination of an oxyethylene and an oxypropylene unit, etc.

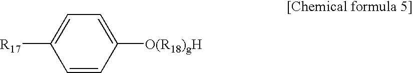

In chemical formula 5, R17 represents a branched or a straight chain saturated hydrocarbon group having about 6 to about 10 carbon atoms, R18 represents an oxyalkylene unit and g represents an integer of from 1 to 15. Preferably, g represents an integer of from 3 to 10. Examples of the oxyalkylene unit of R18 may include an oxyethylene unit (—C₂H₄O—), an oxypropylene unit (—C₃H₆O—), a combination of an oxyethylene and an oxypropylene unit, etc.

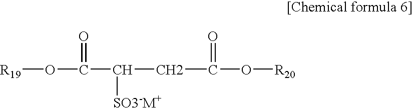

In chemical formula 6, R19 and R20 independently represent branched or a straight chain saturated hydrocarbon groups having about 5 to 12 carbon atoms, and M represents ammonia or alkanolamine. Preferably, R19 and R20 independently have about 7 to about 9 carbon atoms. Examples of ammonia and alkanolamine may include ammonia, mono-ethanol amine, diethanol amine and triethanol amine.

The surfactant improves the dynamic surface tension characteristics of the cleaning solution. The cleaning solution including about 0.01 to about 1.0 weight percent of the surfactant exhibits a dynamic surface tension less than or substantially identical to about 50 dyne/cm at about 6 bubbles/second when measured by a maximum bubble pressure method. When the cleaning solution having the above-mentioned dynamic surface tension value is used, the capillary force generated due to the cleaning solution residues between the photoresist patterns can be effectively reduced. Therefore, the collapse of the photoresist film during the cleaning process can be prevented.

The surfactant may be used in a combination thereof. When two or more surfactants are combined, a surfactant including a high molecular weight of hydrophilic functional groups and liable to dissolve in water can be included as a dissolving agent. This allows a surfactant having a good dynamic surface tension but not readily soluble in water to be easily dissolved in water in a high concentration. Therefore, a cleaning solution having even better dynamic surface tension may be prepared. In addition, when two or more surfactants are combined, a cleaning solution including a surfactant in a high concentration can be prepared, thereby reducing distribution expenses.

About 0 to about 30 weight percent of an organic solvent can be added based on about 70 to about 100 weight percent of the cleaning solution including the solvent and the surfactant.

According to the present invention, the dynamic surface tension characteristics may be improved when an organic solvent is added into the cleaning solution. However, when the added amount of the organic solvent exceeds about 30 weight percent, the organic solvent dissolves the photoresist, damaging the photoresist pattern. Therefore, the amount of organic solvent may be less than or substantially identical to about 30 weight percent. Examples of the organic solvent may include methyl alcohol, ethyl alcohol, isopropyl alcohol, butyl alcohol, etc. These can be used alone or in a combination thereof.

In accordance with an additional embodiment of the present invention, there is provided a method of cleaning a semiconductor device using the above-described cleaning solutions. The method of cleaning a semiconductor device will be described as an example. However, the method of this embodiment is applicable in any application in which the collapse of a minute structure due to a capillary force is possible.

Preferably, the photoresist pattern is formed as follows. The photoresist film is formed on the substrate and the photoresist film is partially exposed to a light. Examples of the light may include a G-line ray, an I-line ray, a laser of krypton fluoride (KrF), a laser of argon fluoride (ArF), an e-beam or an X-ray. Then, the partially exposed photoresist film is developed using a developing solution to form the photoresist pattern.

The cleaning is executed as follows. The substrate on which the photoresist pattern is formed is firstly cleaned using pure water to replace the developing solution. Then, the firstly cleaned substrate is secondly cleaned using the cleaning solution to replace pure water. The cleaning solution is removed by a spin dry process.

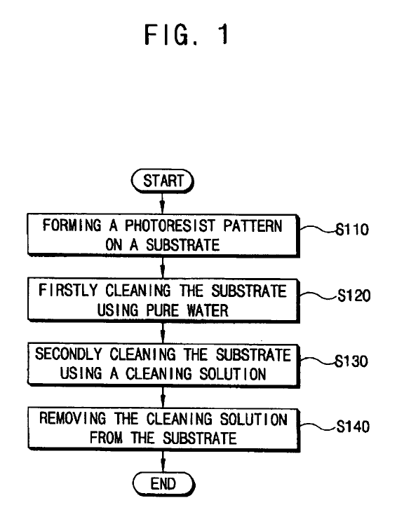

FIG. 1 is a flow chart illustrating a method of cleaning a semiconductor device according to one embodiment of the present invention.

Referring to FIG. 1, a photoresist pattern is formed on a substrate in step S110. Then, the substrate is cleaned to replace a developing solution with the cleaning solution in steps S120 and S130. The cleaning solution is then removed from the substrate on which the photoresist pattern is formed in step S140.

Each step will be described in detail with reference to the attached drawings.

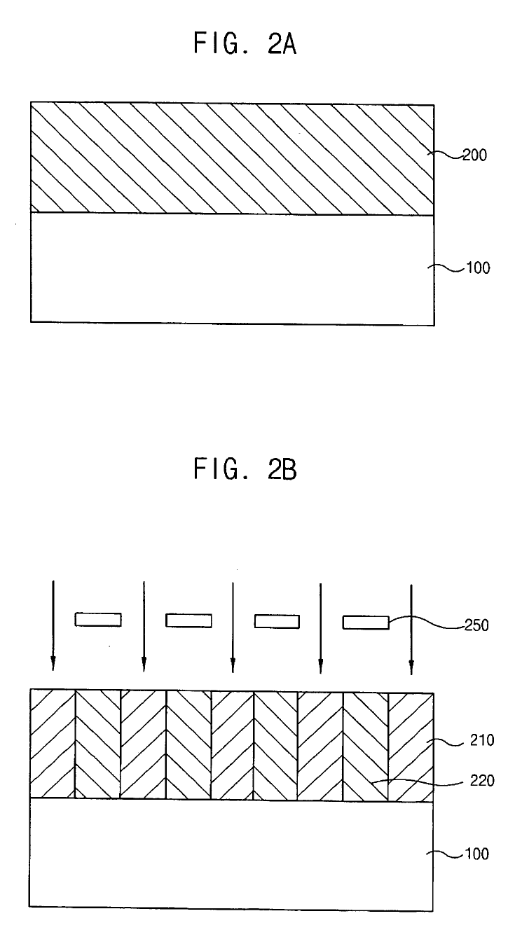

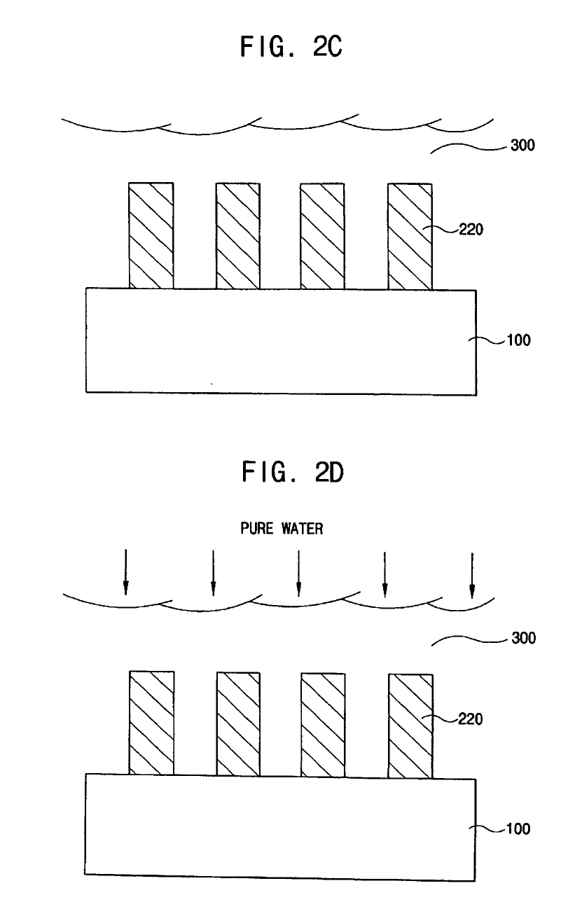

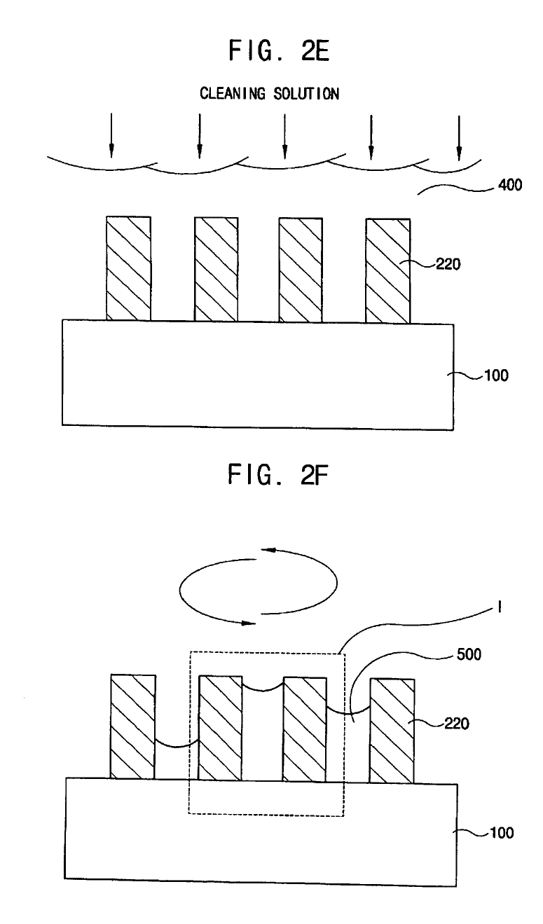

FIGS. 2A to 2F are cross-sectional views illustrating the method of cleaning semiconductor devices according to one embodiment of the present invention.

Referring to FIGS. 2A to 2C, a photoresist film 200 on a partially exposed substrate 100 is developed using a developing solution 300 to form a photoresist pattern 220 in the step S110.

Referring to FIG. 2A, the photoresist film 200 is formed on the substrate 100. The substrate 100 may be a silicon substrate for manufacturing a semiconductor device or a liquid crystal display device (LCD device). A structure such as an oxide layer, a nitride layer, a silicon layer or a metal layer to be patterned by etching using a photolithography may be formed on the substrate 100.

Photosensitive material is coated on the substrate 100 by a coating method such as a spin coating to form the photoresist film 200. The photosensitive material may be a positive photoresist or a negative photoresist. For a positive photoresist, the exposed portion is removed through a subsequent developing process. In the present embodiment, a positive photoresist is used for explanation, however, the application of a negative photoresist also may be included in the present invention.

Another accompanied processes can be selectively implemented. For example, hexamethyldisilazane (HMDS) might be coated on the substrate 100 to increase the adhesiveness between the substrate 100 and the photoresist film 200 before forming the photoresist film 200. An antireflective layer may be additionally formed to prevent a diffused reflection during an exposing process. In addition, an edge bead rinse (EBR) process might be implemented to prevent the contamination of the substrate 100 after forming the photoresist film 200 or a soft baking process may be performed to remove moisture contained in the photoresist film 200.

Referring to FIG. 2B, the photoresist film 200 is partially exposed using a mask 250.

The mask 250 having a circuit pattern for selectively exposing predetermined portion of the photoresist film 200 is positioned over the photoresist film 200. Then, a light is applied onto the photoresist film 200 through the mask 250. Examples of the light may include a G-line ray, an I-line ray, a laser of krypton fluoride (KrF), a laser of argon fluoride (ArF), an e-beam, an X-ray, etc. The exposed photoresist film 210 has a different solubility from that of the unexposed portion of the photoresist film 220. For example, a light having a short wavelength such as a laser of argon fluoride (ArF), an e-beam or an X-ray is employed to manufacture a highly integrated semiconductor device.

Referring to FIG. 2C, the unexposed and exposed photoresist films 220 and 210 are developed using a developing solution 300 such as tetramethyl ammonium hydroxide (TMAH) to complete photoresist patterns 220. When positive photoresist is used, the exposed portion of the photoresist 210 is removed.

Referring to FIGS. 2D and 2E, the substrate 100 on which the photoresist patterns 220 are formed is cleaned using a cleaning solution including a solvent and a surfactant and having a dynamic surface tension of less than or substantially identical to about 50 dyne/cm at about 6 bubbles/second when measured by a maximum bubble pressure method to replace the developing solution 300 with the cleaning solution in the steps S120 and S130.

Referring to FIG. 2D, the substrate 100 on which the photoresist patterns 220 are formed is firstly cleaned using pure water to replace the developing solution 300 with pure water. In particular, a sufficient amount of pure water is applied onto the substrate 100, while simultaneously rotating the substrate 100 to completely replace the developing solution 300 with pure water in the step S120.

Referring to FIG. 2E, the firstly cleaned substrate 100 is secondly cleaned using the cleaning solution to replace the pure water 400 with the cleaning solution. The cleaning solution may include about 99.0 to about 99.99 weight percent of a solvent and about 0.01 to about 1.0 weight percent of a surfactant and has a dynamic surface tension less than or substantially identical to about 50 dyne/cm at about 6 bubbles/second when measured by a maximum bubble pressure method.

The surfactants satisfying the above-mentioned condition of the cleaning solution may include the compounds represented by the above chemical formulae 1 to 6. These can be used alone or in a combination thereof.

As described in detail above, collapse of the photoresist pattern 220 during subsequent removal of the cleaning solution such as a subsequent drying process can be prevented by using the disclosed cleaning solution.

In addition, the dynamic surface tension characteristics can be even further improved when about 0 to about 30 weight percent of an organic solvent is added, and more preferably, from about 5 to about 25 weight percent of an organic solvent, based on about 70 to about 100 weight percent of the cleaning solution. Examples of the organic solvent may include methyl alcohol, ethyl alcohol, isopropyl alcohol, butyl alcohol. These can be used alone or in a mixture thereof.

Referring to FIG. 2F, the cleaning solution 500 is removed from the substrate 100 on which the photoresist pattern 220 is formed in the step S140.

The cleaning solution is removed by a spin dry process. After completing the spin dry process, a new interface is formed between the cleaning solution and gas. When commonly used cleaning solutions such as pure water are used, the time required for reaching a minimum surface tension state is prolonged. That is, the dynamic surface tension characteristics are lowered and the photoresist patterns easily collapse.

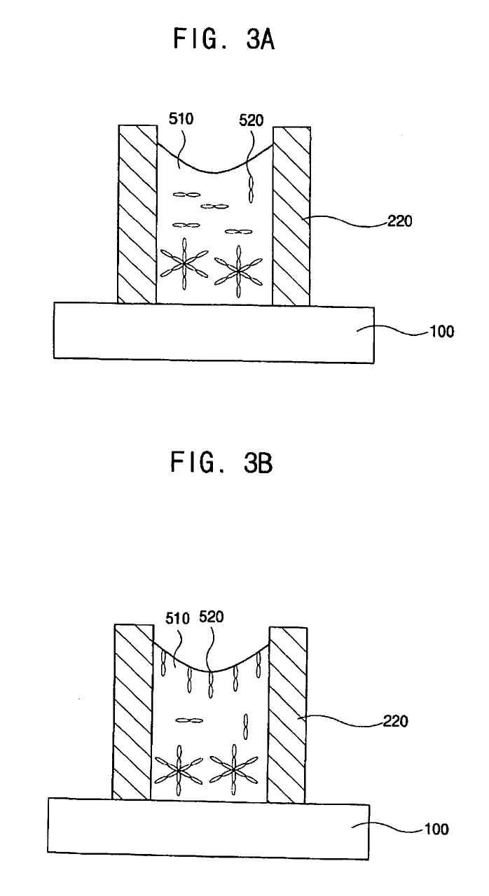

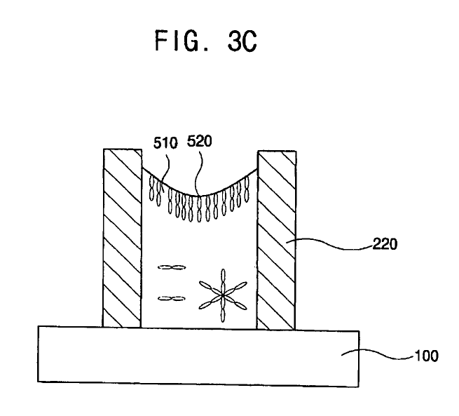

However, the cleaning solution 500 according to the present invention has excellent dynamic surface tension characteristics so that the collapse of the photoresist patterns 220 can be effectively prevented. This phenomenon will be described in detail with reference to the attached drawings. FIGS. 3A to 3C are enlarged cross-sectional views of part I in FIG. 2F illustrating the mechanism of the change of a dynamic surface tension when applying the cleaning method according to one embodiment of the present invention.

Referring to FIG. 3A, right after forming a new gas (for example, an air or a process atmosphere)—liquid (the cleaning solution) interface, the surfactant molecules 520 in the solvent 510 still cannot instantaneously move to the newly formed interface of the gas-liquid. Accordingly, the surface tension of the gas- liquid is the same as that of the pure liquid without the surfactant.

Referring to FIG. 3B, the surfactant molecules 520 in the liquid move to the interface of the gas-liquid, are adsorbed and are arranged as time passes, and the surface tension of the gas-liquid is gradually lowered due to the surfactant molecules 520 at the interface of the gas-liquid.

Referring to FIG. 3C, the newly formed interface of the gas-liquid is saturated with the surfactant molecules 520 to reach a state having the lowest surface tension of the gas-liquid. The interface tension state is an equilibrium surface tension state or a static surface tension state.

When the cleaning solution according to the present embodiment is used, the time required for the solution to reach the state having the minimum surface tension as illustrated in FIG. 3C from the state illustrated in FIG. 3A can be remarkably reduced. Accordingly, the capillary force inducing the collapse of the photoresist pattern is rapidly reduced, preventing the photoresist pattern from collapsing.

According to the present invention, there is provided another method of cleaning a semiconductor device using the above-described cleaning solution. According to the present embodiment, photoresist patterns are formed and a cleaning process is implemented to replace the developing solution with the cleaning solution by cleaning the substrate. Subsequently, the cleaning solution is removed from the substrate on which the photoresist pattern is formed.

The present embodiment is implemented according to the same manner described in the previous embodiment with reference to FIGS. 1, 2A to 2F and 3A to 3C. However, the cleaning solution including a solvent and at least one surfactant selected from the compounds represented by the chemical formulae of 1 to 6 is used at the cleaning step. Preferably, the solution includes about 99.0 to about 99.99 weight percent of the solvent and about 0.01 to about 1.0 weight percent of the surfactant.

The collapse of the photoresist pattern during a subsequent spin drying process for removing the cleaning solution can be prevented by employing the cleaning solution. That is, the time required to reach the state having the minimum surface tension from the state of forming the new gas-liquid interface is remarkably reduced when compared with the time required using pure water. Accordingly, the capillary force inducing the collapse of the photoresist pattern decreases greatly, preventing the photoresist pattern from collapsing.

Additionally, when about 0 to about 30 weight percent of an organic solvent is added to the solution, the dynamic surface tension characteristic is even further improved. Examples of the organic solvent may include methyl alcohol, ethyl alcohol, isopropyl alcohol, butyl alcohol, etc. These can be used alone or in a mixture thereof.

The present invention will be described in more detail with reference to the following examples and comparative examples. Here, the examples are illustrated just for an explanation, and not for limiting the present invention to them.

### EXAMPLE 1

### Preparing Cleaning Solution

A cleaning solution was prepared by mixing 1.0 weight percent of octyl phenol ethoxylate (including about 10 mol of oxyethylene unit) and 99.0% by weight of pure water.

Forming Photoresist Patterns

A commercially available methacrylate photoresist (FARS-C20 manufactured by Fujifilm Arch Co., Ltd., Japan) for exposing to ArF was coated on a semiconductor wafer to have a thickness of about 2700 to about 2900 Å. Subsequently, the exposing amount for individual sectors on the wafer was adjusted using a mask including a test pattern having a pitch of 160 nm to adjust the width of patterns to be formed after developing. In particular, the pattern width was adjusted by 5 nm increments from 70 nm to 110 nm to obtain 9 different widths. The exposure process was carried out using a S306C ArF scanner (NA=0.78) manufactured by Nikon Co., Ltd. Then, the wafer was soft baked at about 110° C. for about 60 seconds and was developed using 2.38% TMAH aqueous solution.

Cleaning

After developing the wafer on which the photoresist pattern was formed, the developing solution was cleaned and replaced using pure water (first cleaning). After the first cleaning, the still wet substrate was cleaned again using the cleaning solution prepared by Example 1 by replacing the pure water with the cleaning solution (second cleaning).

Removing the Cleaning Solution

The replaced cleaning solution was dried out by spinning the water at about 2500 rpm for about 15 seconds.

### EXAMPLES 2-11

Preparing Cleaning Solutions

Cleaning solutions were prepared having different components from the solution prepared in Example 1. Detailed components are described in the following Table 1. The remaining component in the cleaning solution except the surfactant and the organic solvent was pure water.

As shown in Table 1, B represents octyl phenol ethoxylate (including about 10 mol of oxyethylene unit and about 2 mol of oxypropylene unit), C represents tetramethyl decyne diol, D represents decanol ethoxylate, E represents ammonium dioctyl sulfosuccinate, F represents Zonyl FSJ (fluoride-based surfactant commercially available from Du Pont Co., Ltd., U.S.A), and G represents L7614 (silicon-based surfactant commercially available from Union Carbide Co., Ltd., U.S.A). In Example 11, isopropyl alcohol was used as the organic solvent.

Cleaning

The same procedure from the forming of the photoresist patterns to the removing of the cleaning solution described in Example 1 was implemented. Here, the cleaning was implemented using the cleaning solutions prepared from Examples 2-10 instead of that prepared from Example 1.

### Comparative Examples 1-4

Preparing Cleaning Solutions

Cleaning solutions having different components from those of the cleaning solution in Example 1 were prepared. Detailed components are described in the following Table 1. The remaining component of the cleaning solution except the surfactant was pure water.

Cleaning

The same procedure from the forming of photoresist patterns to the removing of the cleaning solution described in Example 1 was implemented. Here, the cleaning was carried out using the four cleaning solutions prepared from Comparative Examples 1-4 instead of that from Example 1.

TABLE 1

| | Surfactant (% by weight) | | | | | | | Organic solvent |
|---|---|---|---|---|---|---|---|---|
| | A | B | C | D | E | F | G | (% by weight) |
| Example 1 | 1.0 | — | — | — | — | — | — | — |
| Example 2 | 0.5 | — | — | — | — | — | — | — |
| Example 3 | 0.1 | — | — | — | — | — | — | — |
| Example 4 | — | 0.1 | — | — | — | — | — | — |
| Example 5 | — | — | 0.05 | — | — | — | — | — |
| Example 6 | — | — | — | 0.1 | — | — | — | — |
| Example 7 | — | — | — | — | 0.1 | — | — | — |
| Example 8 | 0.05 | — | — | 0.05 | — | — | — | — |
| Example 9 | — | 0.05 | — | — | 0.05 | — | — | — |
| Example 10 | 0.3 | — | 0.15 | — | — | — | — | — |
| Example 11 | 0.1 | — | — | — | — | — | — | 20 |
| Comparative | — | — | — | — | — | — | — | — |
| Example 1 | | | | | | | | |
| Comparative | — | — | — | — | — | 0.1 | — | — |
| Example 2 | | | | | | | | |
| Comparative | — | — | — | — | — | — | 0.1 | — |
| Example 3 | | | | | | | | |
| Comparative | — | — | 0.15 | — | — | 0.3 | — | |
| Example 4 | | | | | | | | |

Experiment 1 (Measuring Surface Tension)

The equilibrium surface tension and the dynamic surface tension were measured at a temperature of 25° C. for the cleaning solutions prepared from Examples 1-11 and Comparative Examples 1-4. The results are described in Table 2. The equilibrium surface tension and the dynamic surface tension were, respectively, measured using KT100 and BP2 (trade name manufactured by KRUSS Co., Ltd., Germany).

TABLE 2

| | Equilibrium surface | Dynamic surface tension |
|---|---|---|
| | tension (dyne/cm) | (dyne/cm) |
| Example 1 | 33 | 35 |
| Example 2 | 33 | 37 |
| Example 3 | 33 | 40 |
| Example 4 | 35 | 41 |
| Example 5 | 33 | 37 |
| Example 6 | 29 | 35 |
| Example 7 | 32 | 34 |
| Example 8 | 31 | 37 |
| Example 9 | 33 | 37 |
| Example 10 | 33 | 35 |
| Example 11 | 30 | 37 |
| Comparative Example 1 | 72 | 72 |
| Comparative Example 2 | 26 | 66 |
| Comparative Example 3 | 27 | 61 |
| Comparative Example 4 | 29 | 45 |

According to the result of the surface tension measurement, the dynamic surface tension for the cleaning solutions prepared from Examples 1-11 was within the range of 50 dyne/cm or less at 6 bubbles/second. When comparing these results with that obtained from Comparative Example 1, in which the cleaning solution did not contain the surfactant and contained only pure water, the dynamic surface tension characteristics were not obtained but the same high value of 72 dyne/cm with the equilibrium surface tension was obtained. Referring to the results obtained from Comparative Examples 2 and 3, even though the equilibrium surface tension values were low, the dynamic surface tension values were not good when compared with those obtained in the other examples.

In particular, in Example 5 using the cleaning solution containing tetramethyl decyne diol, the dynamic surface tension characteristics were very good, however, the solubility in water at a temperature of 25° C. was very low (0.05% or less) because the molecular weight of hydrophilic functional groups was very small. In Example 10 using the cleaning solution containing octyl phenol ethoxylate having a large molecular weight of hydrophilic functional groups, octyl phenol ethoxylate functions as a dissolving agent to dissolve tetramethyl decyne diol in pure water in a high concentration, thereby lowering the dynamic surface tension value.

On the contrary, in Comparative Example 4, tetramethyl decyne diol was mixed with Zonyl FSJ and was dissolved in even higher concentration. In this case, the dynamic surface tension characteristics of tetramethyl decyne diol were deteriorated.

Experiment 2 (Observing Collapse of Photoresist Pattern)

Utilizing the cleaning solutions suggested by Examples 1-11 and Comparative Examples 1-4, the collapse of the photoresist pattern was observed by inspecting a substrate on which cleaned photoresist pattern had been formed using an electronic scanning microscope (Hitachi CD-SEM HS-9200 manufactured by Hitachi Co., Ltd., Japan).

The observed results on the photoresist pattern collapse according to the Examples and the Comparative Examples are described in Table 3.

TABLE 3

| | Pattern width (nm) | | | | | | | | |
|---|---|---|---|---|---|---|---|---|---|
| | 110 | 105 | 100 | 95 | 90 | 85 | 80 | 75 | 70 |
| Example 1 | 0 | 0 | 0 | 0 | 0 | 0 | 0 | 0 | 0 |
| Example 2 | 0 | 0 | 0 | 0 | 0 | 0 | 0 | * | * |
| Example 3 | 0 | 0 | 0 | 0 | 0 | 0 | * | * | * |
| Example 4 | 0 | 0 | 0 | 0 | 0 | 0 | * | * | * |
| Example 5 | 0 | 0 | 0 | 0 | 0 | 0 | 0 | * | * |
| Example 6 | 0 | 0 | 0 | 0 | 0 | 0 | 0 | 0 | 0 |
| Example 7 | 0 | 0 | 0 | 0 | 0 | 0 | 0 | 0 | 0 |
| Example 8 | 0 | 0 | 0 | 0 | 0 | 0 | 0 | * | * |
| Example 9 | 0 | 0 | 0 | 0 | 0 | 0 | 0 | * | * |
| Example 10 | 0 | 0 | 0 | 0 | 0 | 0 | 0 | 0 | 0 |
| Example 11 | 0 | 0 | 0 | 0 | 0 | 0 | 0 | * | * |
| Comparative | 0 | * | X | X | X | X | X | X | X |
| Example 1 | | | | | | | | | |
| Comparative | 0 | 0 | * | * | X | X | X | X | X |
| Example 2 | | | | | | | | | |
| Comparative | 0 | 0 | * | * | * | X | X | X | X |
| Example 3 | | | | | | | | | |
| Comparative | 0 | 0 | 0 | 0 | 0 | * | * | * | X |
| Example 4 | | | | | | | | | |

As seen in the results, no photoresist pattern collapse was observed when using the cleaning solutions from Examples 1-11 to the pattern width of 85 nm according to the present invention. In some cases, no collapse was observed even to a pattern width of 70 nm.

In Comparative Example 1, pattern collapse was observed for pattern widths of 100 nm or over. In Comparative Examples 2 and 3, pattern collapse was somewhat prevented when compared with the results from Comparative Example 1. However, pattern collapse was observed for pattern widths of 90 nm or less. In Comparative Examples 2 and 3, the results were not good even though the equilibrium surface tension of the cleaning solution was low. This result verifies that the photoresist pattern collapse largely is dependent on the dynamic surface tension of the cleaning solution.

In particular, in Example 10, octyl phenol etoxylate was added to tetramethyl decyne diol having good dynamic surface tension characteristics but having a low solubility in water to increase the concentration of tetramethyl decyne diol in the cleaning solution by improving the solubility in water. When compared with Example 5, in which tetramethyl decyne diol was used alone, the efficiency of preventing the collapse of the pattern was better in Example 10. For Comparative Example 4, Zonyl FSJ having inferior dynamic surface tension characteristics was used as the dissolving agent. The efficiency of preventing the collapse of the pattern obtainable from Comparative Example 4 was inferior to that of the pattern obtainable from Example 5 in which Zonyl FSJ was not contained.

When a surfactant having a high molecular weight of hydrophilic functional groups and liable to dissolve in water is added as a dissolving agent, the solubility in water of another surfactant that is not soluble in water can be increased and the concentration of the second surfactant can be augmented. Accordingly, the dynamic surface tension characteristics of the cleaning solution can be improved to give a desirable result. In addition, the dynamic surface tension characteristics of the added surfactant as the dissolving agent also improves the performance of the cleaning solution.

According to the present invention, a cleaning solution having good dynamic surface tension characteristics is used to prevent a photoresist pattern from collapsing especially when forming minute photoresist patterns having about 100 nm or less pattern width. Through utilizing minute photoresist patterns, various patterns of highly integrated semiconductor devices can be formed accurately and advantageously. In addition, when two or more surfactants are used in combination, a cleaning solution containing a surfactant in a high concentration can be prepared. Therefore, distribution expenses can be saved.

Thus, a highly integrated semiconductor device having improved reliability may be economically manufactured so that the time and cost required for manufacturing a semiconductor device and for preventing pollution of the environment may be reduced.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

1. A cleaning solution comprising a surfactant and a solvent, wherein the dynamic surface tension of the cleaning solution measured by a maximum bubble pressure method is less than or substantially equal to about 50 dyne/cm at about 6 bubbles/second.

2. The cleaning solution of claim 1, wherein the solution comprises:
about 0.01 to about 1.0 weight percent of the surfactant; and
about 99.0 to about 99.99% weight percent of the solvent.

3. The cleaning solution of claim 1, wherein the surfactant comprises at least one compound selected from the group consisting of the following compounds represented by chemical formulae 1 to 6: 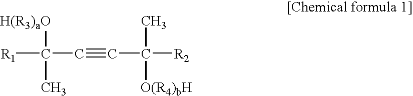
wherein R1 and R2 in chemical formula 1 independently represent branched or a straight chain saturated hydrocarbon groups having 3 to 6 carbon atoms, R3 and R4 independently represent oxyalkylene units, and a and b independently represent integers of 0 to 10; 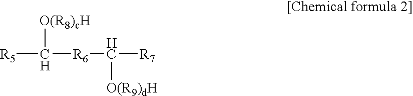
wherein R5, R6 and R7 in chemical formula 2 independently represent hydrogen atoms or branched or straight chain saturated hydrocarbon groups having about 1 to about 11 carbon atoms, R8 and R9 independently represent oxyalkylene units, and c and d represents integers of 0 to 10; 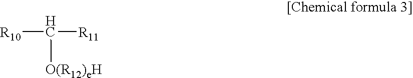
wherein R10 and R11 in chemical formula 3 independently represent hydrogen atoms or branched or straight chain saturated hydrocarbon groups having about 1 to about 12 carbon atoms, R12 represents an oxyalkylene unit, and e represents an integer of 1 to 15; 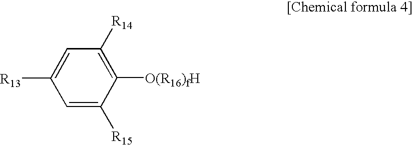
wherein R13, R14 and R15 in chemical formula 4 independently represent hydrogen atoms or benzylmethyl groups having a benzene ring, R16 represents an oxyalkylene unit and f represents an integer of 1 to 15; 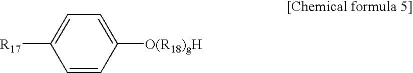
wherein R17 in chemical formula 5 represents a branched or a straight chain saturated hydrocarbon group having about 6 to about 10 carbon atoms, R18 represents an oxyalkylene unit and g represents an integer of 1 to 15; and 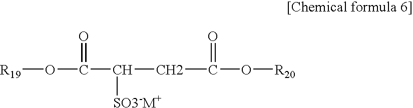
wherein, R19 and R20 in chemical formula 6 independently represent branched or a straight chain saturated hydrocarbon groups having about 5 to about 12 carbon atoms, and M represents ammonia or alkanolamine.

4. The cleaning solution of claim 3, wherein R1 and R2 have about 4 to about 5 carbon atoms, a and b independently represent integers of 0 to 5, c and d independently represent integers of 1 to 5, e represents an integer of 5 to 13, f represents an integer of 3 to 10, g represents an integer of 3 to 10, the oxyalkylene units in R3, R4, R8, R9, R12, and R16 independently comprise an oxyethylene unit (—C₂H₄O—), an oxypropylene unit (—C₃H₆O—) or a combination of an oxyethylene and an oxypropylene unit, R19 and R20 have about 7 to about 9 carbon atoms, and M represents ammonia, mono-ethanol amine, diethanol amine, or triethanol amine.

5. The cleaning solution of claim 1, wherein the solvent comprises pure water.

6. The cleaning solution of claim 1, further comprising about 0 to about 30 weight percent of an organic solvent based on about 70 to about 100 weight percent of the cleaning solution.

7. The cleaning solution of claim 6, wherein the organic solvent comprises at least one solvent selected from the group consisting of methyl alcohol, ethyl alcohol, isopropyl alcohol and butyl alcohol.

8. A cleaning solution comprising a solvent and at least one surfactant selected from the group consisting of the compounds represented by chemical formulae 1 to 6: 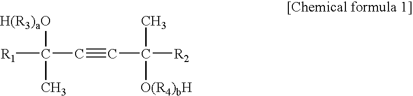
wherein R1 and R2 in chemical formula 1 independently represent branched or a straight chain saturated hydrocarbon groups having about 3 to about 6 carbon atoms, R3 and R4 represent oxyalkylene units, and a and b represent integers of 0 to 10; 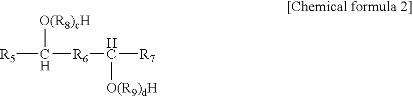
wherein R5, R6 and R7 in chemical formula 2 independently represent hydrogen atoms or branched or straight chain saturated hydrocarbon groups having about 1 to about 11 carbon atoms, R8 and R9 independently represent oxyalkylene units, and c and d represent integers of 0 to 10; 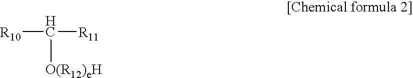
wherein R10 and R11 in chemical formula 3 independently represent hydrogen atoms or branched or straight chain saturated hydrocarbon groups having about 1 to about 12 carbon atoms, R12 represents an oxyalkylene unit, and e represents an integer of 1 to 15; 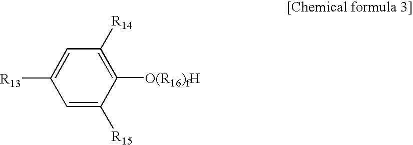
wherein R13, R14 and R15 in chemical formula 4 independently represent hydrogen atoms or benzylmethyl groups having a benzene ring, R16 represents an oxyalkylene unit and f represents an integer of 1 to 15; 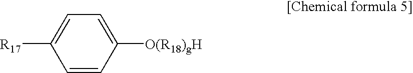
wherein R17 in chemical formula 5 represents a branched or a straight chain saturated hydrocarbon group having about 6 to about 10 carbon atoms, R18 represents an oxyalkylene unit and g represents an integer of 1 to 15; and 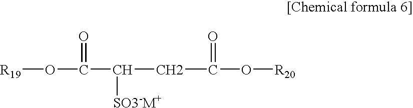
wherein R19 and R20 in chemical formula 6 independently represent branched or straight chain saturated hydrocarbon groups having about 5 to 12 carbon atoms, and M represents ammonia or alkanolamine.

9. The cleaning solution of claim 8, wherein R1 and R2 have about 4 to about 5 carbon atoms, a and b independently represent integers of 0 to 5, c and d independently represent integers of 1 to 5, e represents an integer of 5 to 13, f represents an integer of 3 to 10, g represents an integer of 3 to 10, each of the oxyalkylene units in R3, R4, R8, R9, R12, and R16 comprise an oxyethylene unit (—C₂H₄O—), an oxypropylene unit (—C₃H₆O—) or a combination of an oxyethylene and an oxypropylene unit, R19 and R20 have about 7 to about 9 carbon atoms, and M represents ammonia, mono-ethanol amine, diethanol amine, or triethanol amine.

10. The cleaning solution of claim 8, wherein the solution comprises about 0.01 to about 1.0 weight percent of the surfactant and about 99.0 to about 99.99 weight percent of the solvent.

11. The cleaning solution of claim 7, further comprising about 0 to about 30 weight percent of an organic solvent based on about 70 to about 100 weight percent of the cleaning solution.

12. The cleaning solution of claim 11, wherein the organic solvent includes at least one solvent selected from the group consisting of methyl alcohol, ethyl alcohol, isopropyl alcohol and butyl alcohol.

13. The cleaning solution of claim 8, wherein the solvent is pure water.

14. A method of cleaning a semiconductor device comprising:
developing a partially exposed photoresist film using a developing solution to form a photoresist pattern on a substrate;
cleaning the substrate on which the photoresist pattern is formed to replace the developing solution with a cleaning solution including a surfactant and a solvent, wherein the dynamic surface tension of the cleaning solution is about 50 dyne/cm at about 6 bubbles/second measured by a maximum bubble pressure method; and
removing the cleaning solution from the substrate on which the photoresist pattern is formed.

15. The method of cleaning a semiconductor device of claim 14, wherein forming the photoresist film further comprises:
forming a photoresist film on a substrate;
partially exposing the photoresist film to light using a mask; and
developing the exposed photoresist film using a developing solution to form the photoresist pattern.

16. The method of cleaning a semiconductor device of claim 14, wherein the photoresist film is exposed to a light selected from the group consisting of a G-line ray, an I-line ray, a laser of krypton fluoride (KrF), a laser of argon fluoride (ArF), an e-beam and an X-ray.

17. The method of cleaning a semiconductor device of claim 14, wherein the photoresist film is exposed to light selected from the group consisting of a laser of argon fluoride (ArF), an e-beam and an X-ray.

18. The method of cleaning a semiconductor device of claim 14, wherein cleaning the photoresist pattern further comprises:
firstly cleaning the substrate on which the photoresist pattern is formed using pure water to replace the developing solution with pure water; and
secondly cleaning the firstly cleaned substrate using the cleaning solution to replace the pure water with the cleaning solution.

19. The method of cleaning a semiconductor device of claim 14, wherein the cleaning solution comprises:
about 0.01 to about 1.0 weight percent of the surfactant; and
about 99.0 to about 99.99% weight percent of the solvent.

20. The method of cleaning a semiconductor device of claim 14, wherein the surfactant is at least one compound selected from the group consisting of the following chemical formulae 1 to 6: 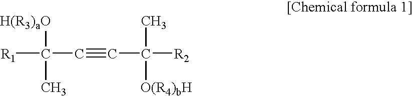
wherein R1 and R2 in chemical formula 1 independently represent branched or a straight chain saturated hydrocarbon groups having about 3 to about 6 carbon atoms, R3 and R4 independently represent oxyalkylene units, and a and b independently represent integers of 0 to 10; 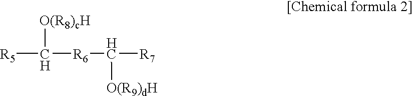
wherein R5, R6 and R7 in chemical formula 2 independently represent hydrogen atoms or branched or straight chain saturated hydrocarbon groups having about 1 to about 11 carbon atoms, R8 and R9 independently represent oxyalkylene units, and c and d represent integers of 0 to 10; 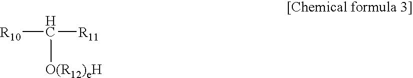
wherein R10 and R11 in chemical formula 3 independently represent hydrogen atoms or branched or straight chain saturated hydrocarbon groups having about 1 to about 12 carbon atoms, R12 represents an oxyalkylene unit, and e represents an integer of 1 to 15; 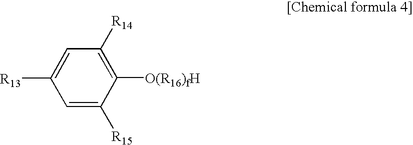
wherein R13, R14 and R15 in chemical formula 4 independently represent hydrogen atoms or benzylmethyl groups having a benzene ring, R16 represents an oxyalkylene unit and f represents an integer of 1 to 15; 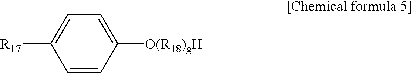
wherein R17 in chemcial formula 5 represents a branched or a straight chain saturated hydrocarbon group having about 6 to about 10 carbon atoms, R18 represents an oxyalkylene unit and g represents an integer of 1 to 15; and 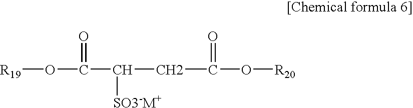
wherein R19 and R20 in chemical formula 6 independently represent branched or straight chain saturated hydrocarbon groups having about 5 to 12 carbon atoms, and M represents ammonia or alkanolamine.

21. The cleaning solution of claim 20, wherein R1 and R2 have about 4 to about 5 carbon atoms, a and b independently represent integers of 0 to 5, c and d independently represent integers of 1 to 5, e represents an integer of 5 to 13, f represents an integer of 3 to 10, g represents an integer of 3 to 10, each of the oxyalkylene units in R3, R4, R8, R9, R12, and R16 comprises an oxyethylene unit (—C₂H₄O—), an oxypropylene unit (—C₃H₆O—) or a combination of an oxyethylene and an oxypropylene unit, R19 and R20 have about 7 to 9 carbon atoms, and M represents ammonia, mono-ethanol amine, diethanol amine, or triethanol amine.

22. The method of cleaning a semiconductor device of claim 14, wherein the solvent comprises pure water.

23. The method of cleaning a semiconductor device of claim 14, wherein the cleaning solution further comprises about 0 to about 30 weight percent of an organic solvent based on about 70 to about 100 weight percent of the cleaning solution.

24. The method of cleaning a semiconductor device of claim 23, wherein the organic solvent is at least one selected from the group consisting of methyl alcohol, ethyl alcohol, isopropyl alcohol and butyl alcohol.

25. The method of cleaning a semiconductor device of claim 14, wherein the cleaning solution is removed by a spin-dry method.

26. A method of cleaning a semiconductor device comprising:
developing a partially exposed photoresist film using a developing solution to form a photoresist pattern on a substrate;
cleaning the substrate on which the photoresist pattern is formed to replace the developing solution with a cleaning solution including a solvent and at least one surfactant selected from the group consisting of the following chemical formulae 1 to 6; and
removing the cleaning solution from the substrate on which the photoresist pattern is formed; 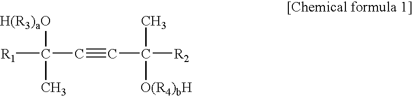
wherein R1 and R2 in chemical formula 1 independently represent branched or a straight chain saturated hydrocarbon groups having about 3 to about 6 carbon atoms, R3 and R4 represent oxyalkylene units, and a and b represent integers of 0 to 10; 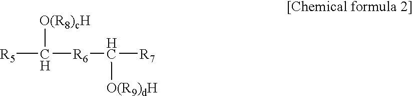
wherein R5, R6 and R7 in chemical formula 2 independently represent hydrogen atoms or branched or straight chain saturated hydrocarbon groups having about 1 to about 11 carbon atoms, R8 and R9 independently represent oxyalkylene units, and c and d represent integers of 0 to 10; 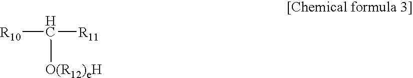
wherein R10 and R11 in chemical formula 3 independently represent hydrogen atoms or branched or straight chain saturated hydrocarbon groups having about 1 to about 12 carbon atoms, R12 represents an oxyalkylene unit, and e represents an integer of 1 to 15; 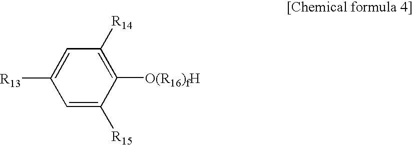
wherein R13, R14 and R15 in chemical formula 4 independently represent hydrogen atoms or benzylmethyl groups having a benzene ring, R16 represents an oxyalkylene unit and f represents an integer of 1 to 15; 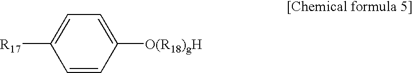
wherein 17 in chemical formula 5 represents a branched or a straight chain saturated hydrocarbon group having about 6 to about 10 carbon atoms, R18 represents an oxyalkylene unit and g represents an integer of 1 to 15; and 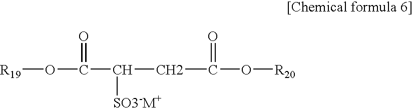
wherein R19 and R20 in chemical formula 6 independently represent branched or straight chain saturated hydrocarbon groups having about 5 to 12 carbon atoms, and M represents ammonia or alkanolamine.

27. The method of cleaning a semiconductor device of claim 26, wherein R1 and R2 have about 4 to 5 carbon atoms, a and b independently represent integers of 0 to 5, c and d independently represent integers of 1 to 5, e represents an integer of 5 to 13, f represents an integer of 3 to 10, g represents an integer of 3 to 10, each of the oxyalkylene units in R3, R4, R8, R9, R12, and R16 comprises an oxyethylene unit (—C₂H₄O—), an oxypropylene unit (—C₃H₆O—) or a combination of an oxyethylene and an oxypropylene unit, R19 and R20 have about 7 to about 9 carbon atoms, and M represents ammonia, mono-ethanol amine, diethanol amine, or triethanol amine.

28. The method of cleaning a semiconductor device of claim 26, wherein the cleaning solution comprises:
about 99.0 to about 99.99% weight percent of the solvent; and
about 0.01 to about 1.0% weight percent of the surfactant.
